(19) United States
(12) Patent Application Publication
(10) Pub. No.: US 2012/0239741 A1
(43) Pub. Date: Sep. 20, 2012

(54) INDUCEMENT SERVER, USER INDUCEMENT SYSTEM AND USER INDUCEMENT METHOD

(76) Inventors: Tatsuo FUJIWARA, Tokyo (JP); Hiroshi YAMAMOTO, Yokohama-shi (JP); Takahiro IMAMICHI, Yokohama-shi (JP)

(21) Appl. No.: 13/370,872

(22) Filed: Feb. 10, 2012

(30) Foreign Application Priority Data
Mar. 18, 2011 (JP) 2011-061267
Apr. 18, 2011 (JP) 2011-092408

(51) Int. Cl. G06F 15/16

(52) U.S. Cl. 709/204

(57) ABSTRACT

A server includes a microprocessor and provides an event, which is of a user participation type, as a first service. The server includes a receiving unit that receives, from a first user terminal connected to the server through a network, action information that identifies an action that corresponds to the event and that is requested by the first user via the first user terminal, and user identification information that distinguishes the first user, an event control unit that performs the action which is identified by the action information, and a notification unit that transmits a notification, to a second server which provides a second service and is connected to the server through the network, the notification including the user identification of the first user, address information that identifies an address of the event, and action information indicating that the action has been performed.

### CROSS-REFERENCE TO RELATED APPLICATIONS

The present application claims priority to and incorporates by reference the entire contents of Japanese Patent Application No. 2011-092408 filed in Japan on Apr. 18, 2011 and Japanese Patent Application No. 2011-061267 filed in Japan on Mar. 18, 2011.

### BACKGROUND OF THE INVENTION

1. Field of the Invention

The present invention relates to Social Networking Service (SNS), and, in particular, to a user inducement server, a user inducement system and a user inducement method.

2. Description of the Related Art

Technology which enables different Social Networking Services (SNS) to cooperate with each other is known in the art (for example, Japanese Patent Application Laid-open No. 2009-199368 is referred to).

According to the technology disclosed to Japanese Patent Application Laid-open No. 2009-199368, the community which is established in a certain SNS can be tied to community of another SNS, although each community remains limited to the respective SNS.

### SUMMARY OF THE INVENTION

However, in the background art discussed above, each user will continue just using the service that the user is currently using. Therefore an additional service cannot induce the user of the other service to join the additional service.

The present invention was made in view of the above circumstances.

An object of the present invention is to provide a server which can induce the user to a service corresponding to the server, an inducement system, and an inducement method.

According to the present invention, there is described a server which provides an event, which is of a user participation type, as a first service.

The server includes a receiving unit that receives, from a first user terminal connected to the server through a network, action information that identifies an action that corresponds to the event and that is requested by the first user via the first user terminal, and user identification information that distinguishes the first user, an event control unit that performs the action which is identified by the action information, and a notification unit that transmits a notification, to a second server which provides a second service and is connected to the server through the network, the notification including the user identification of the first user, address information that identifies an address of the event, and action information indicating that the action has been performed.

According to the present invention, a system includes a first server which includes a microprocessor and provides an event, which is of a user participation type, as a first service and a second server which includes a microprocessor and provides a second service and is connected to the first server through a network.

The first server includes a receiving unit that accepts, from a first user terminal connected to the first server through the network, action information, which identifies an action that corresponds to the event and that is requested by the first user via the first user terminal, and user identification information that distinguishes the first user, and an event control unit that performs the action which is identified by the action information, a notification unit that transmits a notification, to the second server, the notification including the user identification of the first user, address information that identifies an address of the event, and action information indicating that the action has been performed.

The second server includes a transmitting unit that posts, as the first user in the second service, a message indicating that the action has been performed and including the event address based on the user identification, the address information, and the action information.

According to the present invention, there is described a method of providing an event, which is of a user participation type, as a first service. The method includes accepting, from a first user terminal through a network, action information that identifies an action that corresponds to the event and that is requested by the first user via the first user terminal, and user identification information that distinguishes the first user, performing the action which is identified by the action information, and transmitting a notification, to a second server which provides a second service and is connected to the server through the network, the notification including the user identification of the first user, address information that identifies an address of the event, and action information indicating that the action has been performed.

According to the present invention described above, it is possible to provide a user inducement server, a user inducement system and a user inducement method in which a user of another service is induced to the service corresponding to the user inducement server

### BRIEF DESCRIPTION OF THE DRAWINGS

FIG. 1 is a diagram illustrating a user inducement system according to a first embodiment of the present invention;

FIG. 2 is a block diagram of a first server according to a first embodiment of the present invention;

FIG. 3 is a block diagram of a second server according to a first embodiment of the present invention;

FIG. 4 is a diagram illustrating a first following user table according to a first embodiment of the present invention;

FIG. 5 is a flowchart illustrating an event generating operation of a user inducement system according to a first embodiment of the present invention;

FIG. 6 is a diagram illustrating an event selection screen according to a first embodiment of the present invention;

FIG. 7 is a diagram illustrating a new event generation screen according to a first embodiment of the present invention;

FIG. 8 is a diagram illustrating an event information table according to new event generation phase of a first embodiment of the present invention;

FIG. 9 is a diagram illustrating a time line screen according to a first embodiment of the present invention;

FIG. 10 is a diagram illustrating an event selection screen according to a first embodiment of the present invention;

FIG. 11 is a diagram illustrating an event screen according to a first embodiment of the present invention;

FIG. 12 is a flowchart illustrating a message posting operation of a user inducement system according to a first embodiment of the present invention;

FIG. 13 is a diagram illustrating an event information table according to a first message posted phase of a first embodiment of the present invention;

FIG. 14 is a diagram illustrating an event screen according to a first message posted phase of a first embodiment of the present invention;

FIG. 15 is a diagram illustrating an event screen according to a second message posted phase of a first embodiment of the present invention;

FIG. 16 is a diagram illustrating an event information table according to a second message posted phase of a first embodiment of the present invention;

FIG. 17 is a block diagram of a first server according to a second embodiment of the present invention;

FIG. 18 is a block diagram of a first server according to a third embodiment of the present invention;

FIG. 19 is a diagram illustrating a notification setting information table according to a third embodiment of the present invention;

FIG. 20 is a block diagram of a first server according to a fourth embodiment of the present invention;

FIG. 21 is a block diagram of a first server according to a fifth embodiment of the present invention;

FIG. 22 is a diagram illustrating a first precedent user table according to a fifth embodiment of the present invention;

FIG. 23 is a block diagram of a first server according to a sixth embodiment of the present invention; and

FIG. 24 is a diagram illustrating a second precedent user table according to a sixth embodiment of the present invention.

### DETAILED DESCRIPTION OF THE PREFERRED EMBODIMENTS

Hereinafter, exemplary embodiments of the present invention will be described with reference to the accompanying drawings.

### A First Embodiment

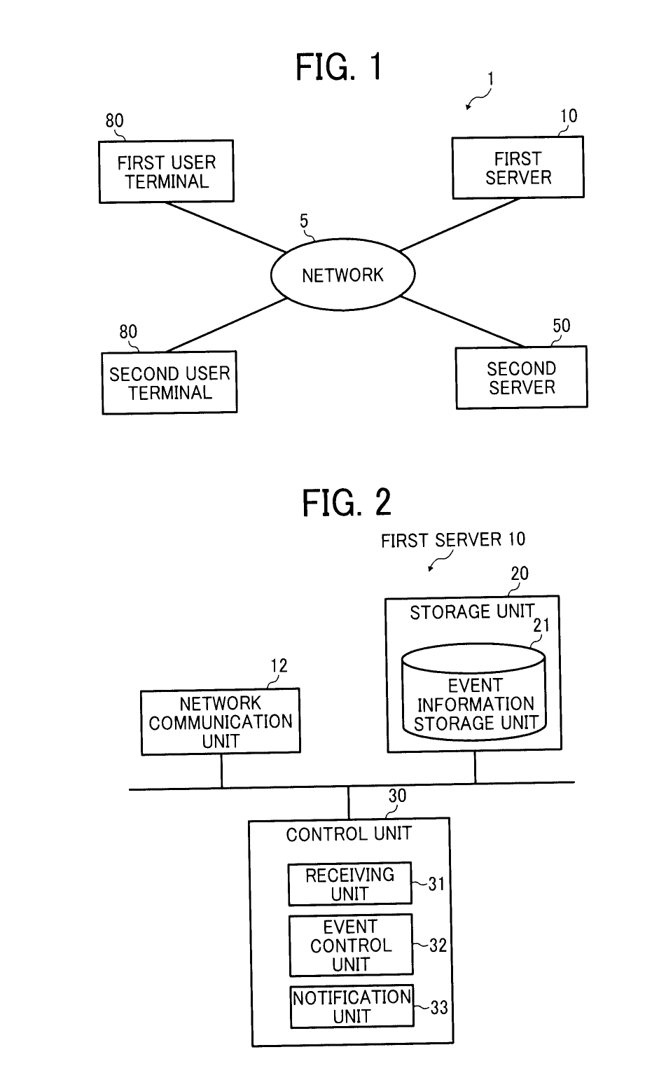

Firstly, a system configuration of a user inducement system according to a first embodiment of the present invention will be described. FIG. 1 is a diagram illustrating the user inducement system 1 according to the first embodiment of the present invention. As illustrated in FIG. 1, the user inducement system 1 according to the first embodiment of the present invention includes a first server 10 that is connected to a network 5, such as the Internet, and a second server 90, a first user terminal 80, a second user terminal 90, which are each connected to the network 5. In the example illustrated in FIG. 1, only the first user terminal 80 and the second user terminal 90 are shown as user terminals. However, it is also possible that additional user terminals are provided as necessary.

The first server 10 provides an event, which is of a user participation type, as a first service. In particular, the first server 10 provides a Social Networking Service (SNS) which enables a user to participate in the event through posting photographs and comments on the event. FIG. 2 is a block diagram of the first server 10 according to the first embodiment of the present invention. As illustrated in FIG. 2, the first server 10 includes a network communication unit 12, a storage unit 20, and a control unit 30.

The network communication unit 12 performs communication with external devices such as the second server 50, the first user terminal 80, and the second user terminal 90. The network communication unit 12 is implemented with a network communication device such as a network interface card.

The storage unit 20 stores therein various computer programs which are executed in the first server 10 and various data which is used for various processes in the first server 10. The storage unit 20 includes a storage device which can store data magnetically, optically or electrically, such as a hard disk drive (HDD), a solid state drive (SSD), a Memory card, an optical disk, or a random access memory (RAM). The storage unit 20 includes an event information storage unit 21. The event information storage unit 21 will be described later.

The control unit 30 serves as a controller for controlling each of the units in the first server 10, and is implemented with a microprocessor based control device such as a central processing unit (CPU). The control unit 30 includes a receiving unit 31, an event control unit 32 and a notification unit 33.

The receiving unit 31 receives, from the first user terminal 80, action information which indicates an action related to the event that the first user has performed by means of the first user terminal 80 and user identification information that distinguishes the first user.

There are a plurality of actions which are seen as being “an action related to the event” such as a generating action which generates the event, a posting action which posts a photograph and/or a message, and a finishing action which finishes the event. Also there is a regarding action that includes posting an opinion about the posted photograph and/or messages which are seen as being “the action related to the event.”

The regarding action is performed by a user and relates to a photograph and/or message that is posted by another user.

In the case in which the “action related to the event” is a generating action, the action information includes action identification which indicates that the performed action is a generating action and which includes an event name of the generated event. In the case in which the “action related to the event” is a posting action, the action information includes action identification which indicates that the performed action is a posting action, and which includes image data of a posted photograph and/or text data of a posted comment. In the case in which the “action related to the event” is a finishing action, the action information includes action identification which indicates that the performed action is a finishing action. In the case in which the “action related to the event” is a regarding action, the action information includes action identification which indicates that the performed action is a regarding or approval action and which includes identification of the liked or approved of photograph and message such as via a photograph name and a comment name.

The user identification information which distinguishes the first user includes information such as account information (User ID and Password) of the first user. In the case in which the “action relating to the event” is the posting action, the finishing action or the regarding action, the receiving unit 31 also receives event identification information which distinguishes the event from the first user terminal 80. The event identification information includes information such as an event ID.

The event control unit 32 generates an action which is indicated by the action information received by the receiving unit 31.

In the case in which the action identification, included in the action information, indicates a generating action, the event control unit 32 holds a storage region for the generated event in the event information storage unit 21 and generates the event ID and an event address.

The event address is location information such as a uniform resource locator (URL). The event control unit 32 stores the event ID, an event name of the generated event included in the action information, the user ID of a user who generates the event (in this embodiment, the user identification information of the first user), and the event address in the storage region such that these elements are stored in correspondence to (linked to) each other.

In the case in which the action identification included in the action information indicates a posting action, the event control unit 32 obtains the event address corresponding to the received event ID with reference to data in the event information storage unit 21. And the event control unit 32 generates, for the event corresponding to the obtained event address, a photograph based on the image data and/or a comment based on the text data. On this occasion, the event control unit 32 generates a time stamp indicating a time when the photograph and/or comment were generated. The event control unit 32 stores the user ID received with the receiving unit 31, the image data of the posted photograph and/or text data of the posted comment included in the action information and the generated time stamp in the event information storage unit 21 such that these elements are stored in correspondence with (linked to) the received event ID.

In the case in which the action identification included in the action information indicates a regarding action, the event control unit 32 obtains the event address corresponding to the received event ID with reference to data in the event information storage unit 21. And the event control unit 32 generates, for the event corresponding to the obtained event address, a photograph based on the image data and/or a comment based on the text data. The event control unit 32 stores the user ID received by the receiving unit 31 and the identification of the liked or approved of photograph and/or message (such as a photograph name and a comment name) included in the action information in the event information storage unit 21 such that these elements are stored in correspondence with (linked to) the received event ID.

In the case in which the action identification included in the action information indicates a finishing action, the event control unit 32 obtains the event address corresponding to the received event ID with reference to data in the event information storage unit 21. The event control unit 32 stores the user ID received by the receiving unit 31 as a finisher of the event in the event information storage unit 21 such that the user id is stored in correspondence with (linked to) the received event ID. When the user ID is stored as the finisher in the event information storage unit 21, the posting action becomes unavailable so that additional posting cannot be performed by any user. Basically, the event control unit 32 does not perform the posting action once the user ID is stored as the finisher in the event information storage unit 21.

A notification unit 33 provides a notification of a) the user identification information, b) the event address, and c) the action performed information indicating that the action has been performed, to the second server 50 which provides the second service. In the case in which the event control unit 32 generates an event, the notification unit 33 acquires text data indicating that the event has been generated, as the “action performed information.” In the case in which the event control unit 32 generates, for the event corresponding to the obtained event address, a photograph based on the image data and/or a comment based on the text data, the notification unit 33 acquires text data indicating that a photograph and/or a comment are posted, as the “action performed information.” In the case in which the event control unit 32 finishes an event, the notification unit 33 acquires text data indicating that the event is finished, as the “action performed information.” In the case in which an event control unit 32 posts the a liked or approved of opinion to the posted photograph and/or message, the notification unit 33 acquires text data indicating that the liked opinion has been posted, as the “action performed information.”

A second server 50 sends a message that indicates that the action is performed and that includes the event address as a message sent by the first user, based on the user identification information, the event address, and the action performed information sent by the notification unit 33. In this embodiment, it is assumed that the user uses the same account in both the first service and the second service. However, it is also possible that the user may use two different accounts for the first service and the second service. The second server 50 providing the second service will be described after.

The notification unit 33 transmits a notification, to the first user terminal 80, which includes event screen information of the event whose action is generated by the event control unit 32. The first user terminal 80 displays the event screen on a display unit of the first user terminal 80 based on the event screen information.

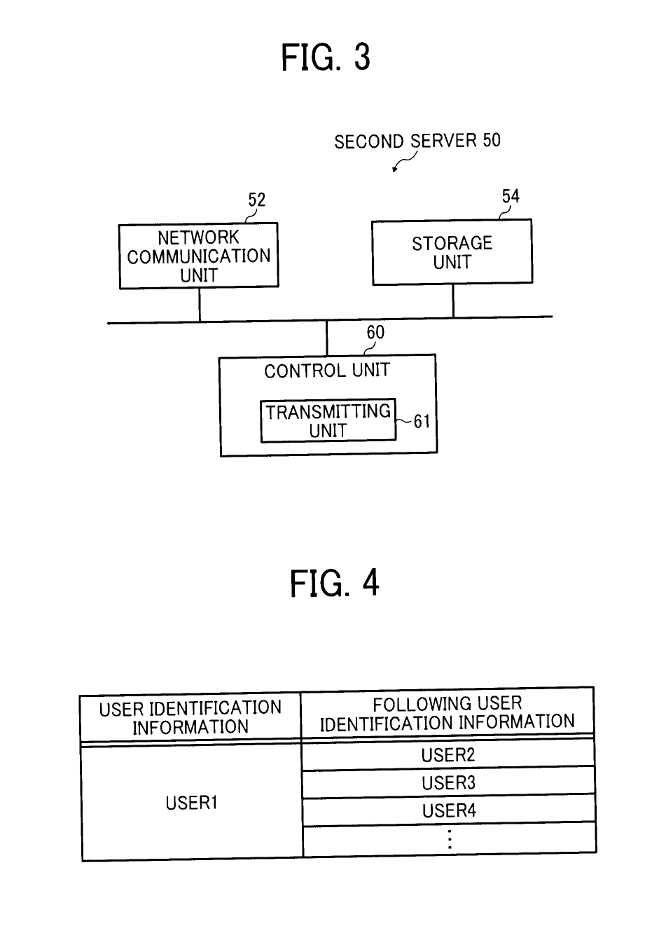

The second server 50 provides the second service, such as Twitter™ in this embodiment of the present invention, but it is not limited to Twitter™. It includes any Social Networking Service such as Facebook™. FIG. 3 is a block diagram of the second server 50 according to the first embodiment of the present invention. As illustrated in FIG. 3, the second server 50 includes a network communication unit 52, a storage unit 54, and an operation unit 60.

The network communication unit 52 performs communication with the external devices such as the first server 10, the first user terminal 80, and the second user terminal 90. The network communication unit 52 is implemented with a network communication device such as a network interface card.

The storage unit 54 stores therein various computer programs which are executed in the second server 50 and various data which are used for various processes in the second server 50. The storage unit 54 includes the storage device which is able to store data magnetically, optically or electrically, such as a hard disk drive (HDD), a solid state drive (SSD), a memory card, an optical disk, or a random access memory (RAM).

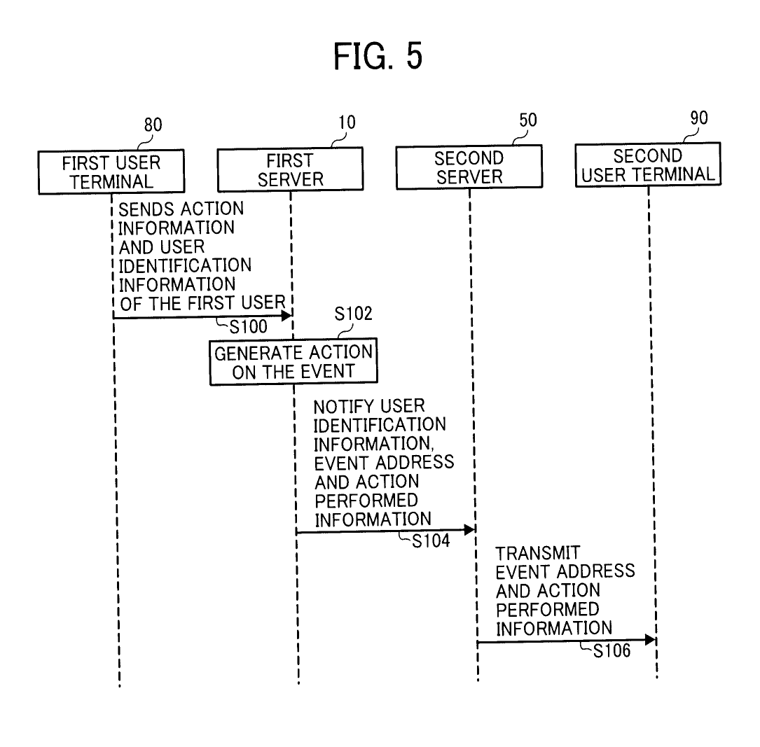

The storage unit 54 stores a “following user table.” The following user table includes “user identification information” and “following user identification information” corresponding thereto for each user identification information. The following user identification information indicates a following user who follows the user indicated by the user identification. The following user is a user who receives a message sent by the first user in the second service. In this embodiment the second service is Twitter™ and the following user is a user who follows the first user. As illustrated in FIG. 4, the storage unit 54 stores a first following user table. The first following user table includes “user1” as the user identification information of the first user and “user2, user3, user4 . . . , etc,” as the following user identification information of following users who follow the first user. Also the storage unit 54 stores a “precedent user table.” The precedent user table includes the user identification information and “precedent user identification information,” which indicates a precedent user who is followed by the first user, for each user identification information entry. The precedent user is the user from whom a first user receives a message. In this embodiment that the second service is Twitter™ and the precedent user is the user whom the first user follows.

The control unit 60 serves as the controller for controlling each unit in the second server 50, and is implemented with the microcontroller based control device such as Central Processing Unit (CPU). The control unit 60 includes a transmitting unit 61.

When the identification information of the first user, the event address, and the action performed information is sent from the first server 10, the second server 50 posts a message indicating that the action has been performed and including the event address, as a message sent by the first user. This message is generated based on the user identification information, the event address, and the action performed information transmitted in a notification by the notification unit 33 of the first server. The transmitting unit 61 of the second server 50 posts the message indicating that the action has been performed and including the event address, as a message sent by the first user. Concretely, the transmitting unit 61 acquires each user ID of the first following users with reference to the first following user table, based on the user ID of the first user which is identified by the first user identification information, stored by a storage unit 54. In this embodiment, as is illustrated in FIG. 4, the transmitting unit 61 acquires “user2” and so on as the user IDs of the first following users. Further, the transmitting unit 61 sends, to the first following users (such as “user2”, etc.), the message indicating that the action has been performed and including the event address. The message is generated based on the identification information of the first user, the event address, and action performed information. In this embodiment, the second service is Twitter™ and the transmitting unit 61 performs a “tweet process” which includes transmitting the message indicating that the action has been performed and the event address, as the first user. Thus, by sharing this information by the tweet process, users that follow the first user in the second service can be induced to participate in the event in the first service.

Further, the first user terminal 80, which is illustrated in FIG. 1, may be used by the first user. In this embodiment, the first user terminal 80 is a portable terminal device such as a mobile telephone, a personal digital assistant (PDA), and/or a game machine. The first user terminal 80 is not limited to the portable terminal and may include a personal computer (PC). The first user performs an action for the event, which is provided by the first server 10 as the first service, with the first user terminal 80. When the first user performs the action for the event, the first user terminal 80 sends action information and the user identification information of the first user to the first server 10. As premises for this example, it is assumed that the first user, who uses the first user terminal 80, has already participated in the event in the first service.

Further, the second user terminal 90, which is illustrated in FIG. 1, may be used by the second user. In this embodiment, the second user terminal 90 may be the portable terminal device such as the mobile telephone, the personal digital assistant (PDA), and/or the game machine. However, the second user terminal 90 is not limited to the portable terminal and may include a personal computer (PC). A second user is able to access the message posted by the first user in the second service, which is provided by the second server 50, with the second user terminal 90. As premises for this example, it is assumed that the second user, who uses the second user terminal 90, is one of the first following users of the first user and will be a new user of a first service (not currently enrolled in the first service) as a result of participating in the event in the first service.

Next, an operation of the user inducement system according to the first embodiment will be described. FIG. 5 is a flowchart illustrating an event generating operation of the user inducement system according to the first embodiment of the present invention.

The operation in which the user inducement system generates an event will be described with reference to FIG. 5.

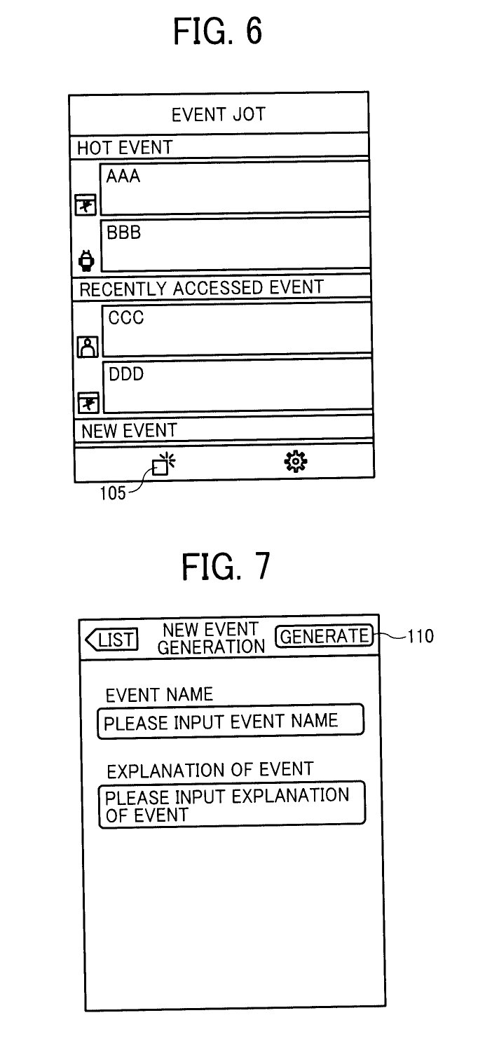

Initially, when the first user accesses the first server 10 and enters account information of the first user into the first terminal 80, an event selection screen is displayed on the display unit of the first user terminal 80 as a first screen. FIG. 6 is a diagram illustrating the event selection screen according to the first embodiment of the present invention. As illustrated in FIG. 6 a plurality of events (“AAA”, “BBB”, “CCC”, “DDD”) are displayed on the screen.

The displayed events are classified as “Hot event” or featured event and as “Recently accessed event” on the screen. “Hot event” indicates that the event which is classified as a “Hot event” has a high activity level. The activity level is determined based on the number of times the event is accessed or browser and the number of times that the event includes therein a post.

Increases in the number of access times and the number of posts, increases the activity level. Next, a first user selects an event generation button 105 on the event select screen illustrated in FIG. 6. In response to the selection of the event generation button, a new event generation screen illustrated in FIG. 7 is displayed on the display unit of the first user terminal 80. When the first user inputs an event name and explanation of the event and selects the generation button 110 on the new event generation screen illustrated in FIG. 7, an event generation request is sent to the first server 10 from the first user terminal 80. Alternatively, a user may also be able to input a start time of the event and a finish time of the event on the new event generation screen illustrated in FIG. 7.

When an event generation request is complete on the event generation screen illustrated FIG. 7, the first user terminal 80 sends the action information, which includes the action identification, which indicates that a performed action is the generating action, and the event name of the generated event, and sends the user identification information of the first user, to the first server 10. In this embodiment, for example, the event name is “A year-end meeting” and the user identification of the first user is “user1”.

Next, the receiving unit 31 of the first server receives the action information and the user identification information of the first user which is sent by the first user terminal 80 in step S100.

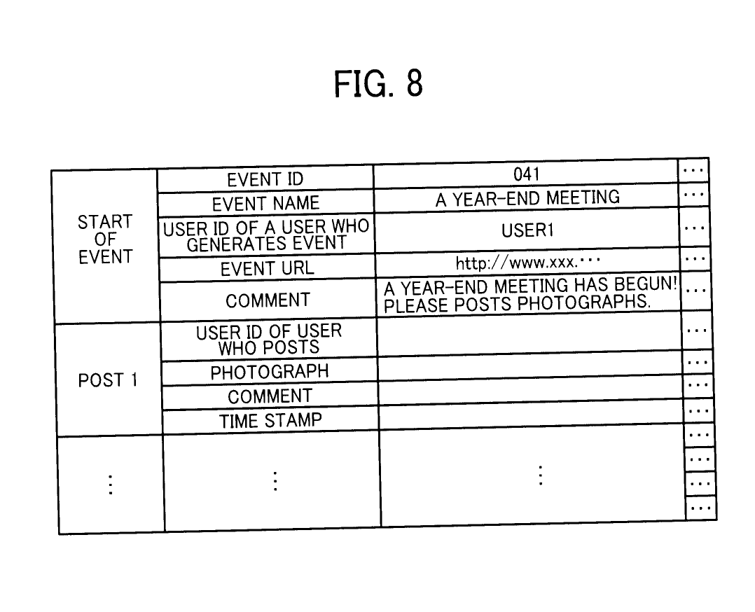

When the receiving unit 31 receives the action information, which includes action identification, which indicates that the performed action is the generating action, and the user identification information of the first user, the event control unit 32 allocates the storage region for the generated event in the event information storage unit 21, and generates the event ID and the event address in step S102. In this embodiment, for example, the event ID is “041” and the event address is “http://www.xxx.????”, the event name is “A year-end meeting”, and the user identification of the first user is “user1”. The event control unit 32 stores the generated event ID, the event name included in the action information, the user identification of a user who generates the event (in this embodiment, the user identification of a user who generates the event is the user identification of the first user, which is received by a receiving unit 31), and the event address in the storage region allocated to the generated event in the event information storage unit 21, such that these elements are stored in correspondence with (linked to) each other (as is illustrated in FIG. 8).

Next, the notification unit 33 acquires text data indicating that the event has been generated, as action performed information from the storage unit 20. Further, the notification unit 33 transmits a notification, to a second server 50, which includes user identification information of a first user, an event address, and the action performed information, in step S104.

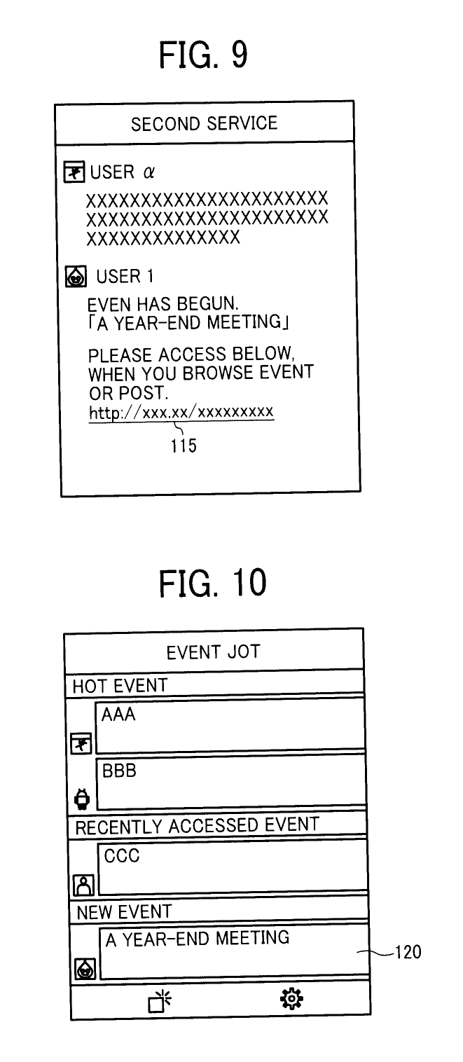

When the user identification information of the first user is received, the transmitting unit 61 acquires each user ID (“user2”, “user3”, “user4”) of the first following users by referencing the first following user table illustrated in FIG. 4 in a storage unit 54, based on the user ID (“user1”) of the first user which is identified by the first user identification information. Further, the transmitting unit 61 posts (performs the “tweet process”), as the first user, to the first following users (such as “user2”), a message indicating that the event has been generated and including the event address, in step S106. Hereby, when the second user accesses the second server 50 and inputs account information of the second user via the second user terminal 90, a time line screen, which is illustrated in FIG. 9, is displayed on the second user terminal 90. Thus, the first following user (such as “user2”) can be encouraged to participate in the event in the first service.

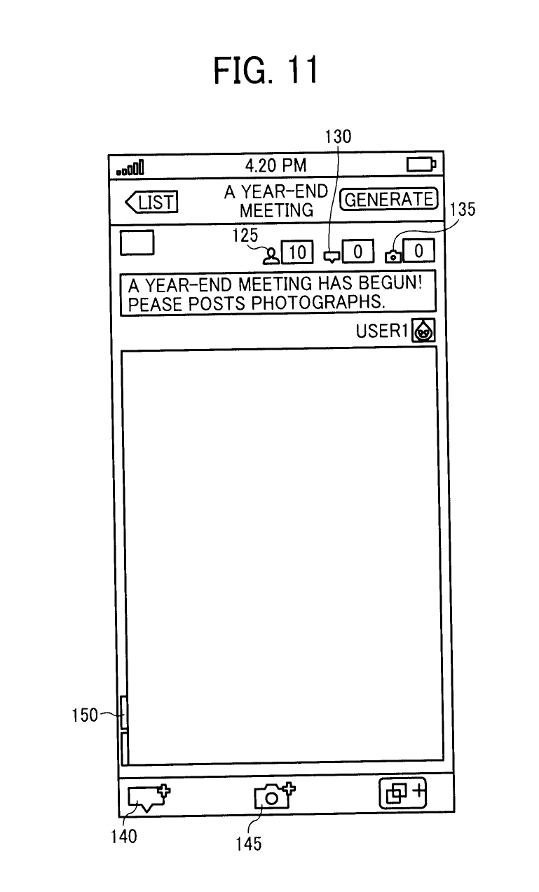

Concretely, when the second user designates the event URL 115 on the time line screen illustrated in FIG. 9, the event selection screen, which is illustrated in FIG. 10, is displayed on the second user terminal as an activation screen. Further, in an alternate embodiment, the second user terminal 90 downloads an application for optimizing UI of the first service in response to the event URL 115 being designated and before the event selection screen is displayed. Additionally, in another embodiment, the second user may input a user account after the event URL 115 is designated before the event selection screen is displayed. FIG. 10 is a diagram illustrating an event selection screen according to the first embodiment of the present invention. “A year-end meeting 120” is displayed on the event selection screen illustrated FIG. 10 as a new event. When the second user selects “A year-end meeting 120” on the event selection screen illustrated in FIG. 10, the event screen illustrated in FIG. 11 is displayed on the display unit of the second user terminal 90. Thus, the second user, with the second user terminal 90, is able to participate in the event “A year-end meeting 120” and is able to post photographs and comments.

As illustrated in FIG. 11, the number next to icon 125 indicates the number of times the event “A year-end meeting” has been viewed or browsed. The number next to icon 130 indicates the number of posted comments for the event “A year-end meeting”.

The number next to icon 135 indicates the number of posted photographs for the event “A year-end meeting”. Further, a comment button 140 is used for posting comments for the event “A year-end meeting”. A camera button 145 is used for posting photographs for the event “A year-end meeting”. A mark 150 indicates activity level of the event. And when activity level is high, the mark increases in length, in a direction up the event screen. When activity level is high, the event is classified as a “Hot event” on the screens illustrated in FIG. 6 and FIG. 10. When the first user generates the event on the new event generation screen illustrated in FIG. 7, the event screen illustrated in FIG. 11 is displayed on the first user terminal 80 also.

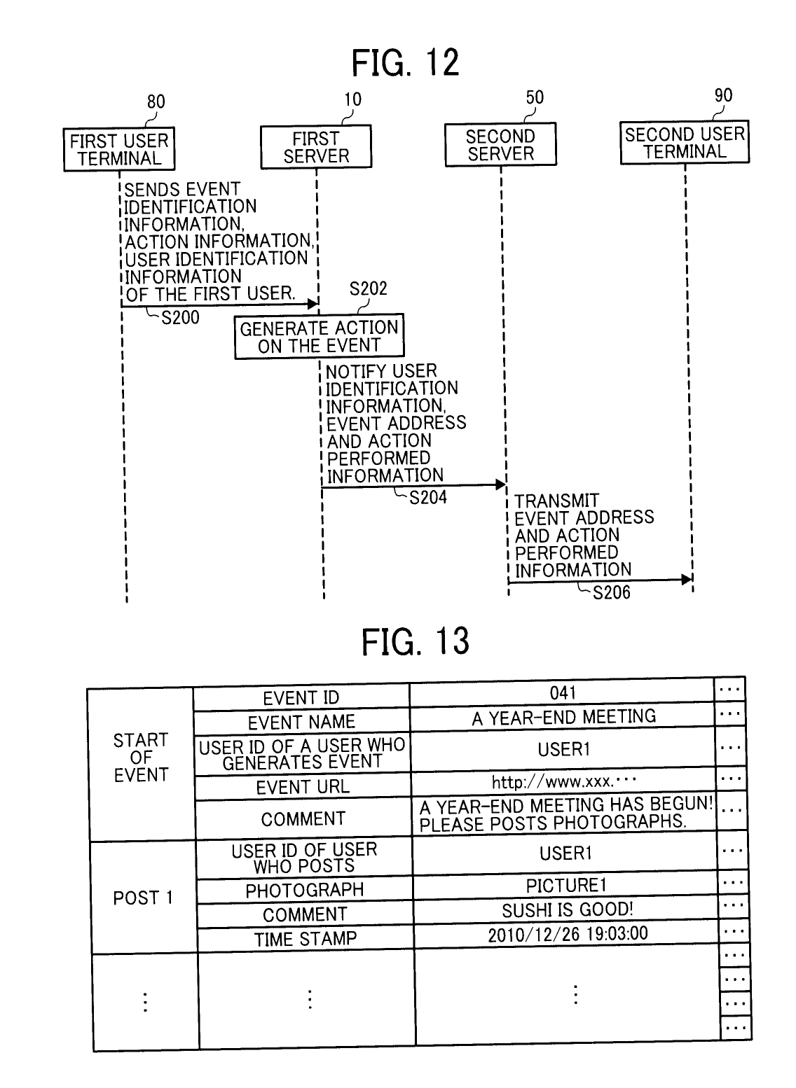

FIG. 12 is a flowchart illustrating a message posting operation of the user inducement system 1 according to the first embodiment. With reference to FIG. 12, a flow of the posting operation will be described. As premises for the present example, it is assumed that the event screen illustrated in FIG. 11 is displayed on the first user terminal 80 and the first user posts a photograph on the event screen.

When the first user designates the camera button 145 on the event screen illustrated in FIG. 11, a shooting screen is displayed on the first user terminal 80. Also, when the first user designates the comment button 140 on the event screen illustrated in FIG. 11, a comment input screen is displayed on the first user terminal 80.

When the first user takes a picture on the shooting screen, the first user terminal 80 sends, to the first server 10, the event identification, the action identification, which indicates that the performed action is a posting to the event, the action information, including image data of that photograph and/or text data of comments, and the user identification of the first user. In this example, the event identification is “041”, the photograph is “picture1”, the comment is “Sushi is delicious!”, and the user identification of the first user is “user1”. Then, the receiving unit 31 receives the event identification information, the action information, and the user identification of the first user, in step S200. In this embodiment, the user is able to add comments to an existing photograph and post the comments along with the photograph.

When the receiving unit 31 of the first server receives the event identification information, including the action identification, which indicates the performed action is posting to the event, and the user identification of the first user, the event control unit 32 retrieves the event ID “041” from the event information storage unit 21. Next, the event control unit 32, for the event indicated by event address corresponding to retrieved event ID, transforms the photograph (image data) and the comment (text data) from the data included in the action information. At this conjuncture, the event control unit 32 generates a time stamp for the photograph (image data) and the comment (text data), in step S202. In this example, the time stamp is “2010/12/26 19:03:00”. Then, as is illustrated in FIG. 13, the event control unit 32 stores, linked to retrieved event ID, the user identification of the poster (in this example, the user identification of the first user), the image data (photograph) and the text data (comment), and the time stamp in the storage region in the event information storage unit 21.

The notification unit 33 acquires text data indicating that the photograph and message have been posted to the event in the storage unit 20, as the action performed information.

The notification unit 33 then transmits a notification, to the second server 50, including the user identification information, the event address indicating URL of the event, and the acquired action performed information, in step S204.

When the user identification of the first user is received, the transmitting unit 61 acquires each user ID (“user2”, “user3”, “user4”) of the first following users by referencing the first following user table illustrated in FIG. 4 in the storage unit 54, based on the user ID (“user1”) of the first user, which is indicated by the first user identification information. Further, the transmitting unit 61 posts (performs “tweet process”) as the first user, to the first following users (such as “user2”), a message indicating that the photograph and the comment are posted and including the event address, in step S206. Hereby, when the second user accesses the service provided by the second server 50 and inputs the account information of the second user via the second user terminal 90, the event address and the posted photograph and the comment are displayed in the time line screen on the second user terminal 90. Thus, the first following users are encouraged to participate in the event in the first service.

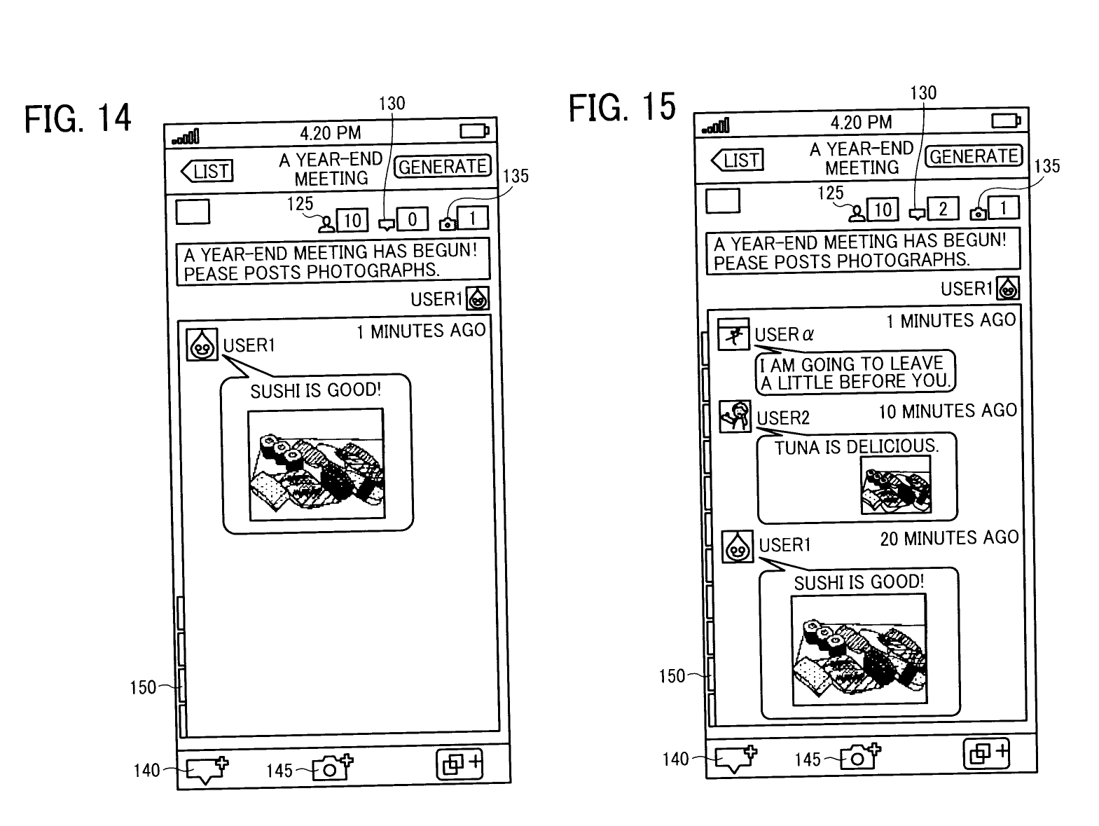

FIG. 14 is a diagram illustrating the event screen according to the photograph and the message posting phase of this embodiment. As illustrated in FIG. 14, the name of the first user (user identification), the posted photograph and the comments, and the amount of time that has elapsed since the post are displayed on the event screen illustrated in FIG. 14. Further, the mark 150 on the event screen illustrated in FIG. 14 is longer than the mark 150 on the event screen illustrated in FIG. 11. This change indicates that activity level is rising.

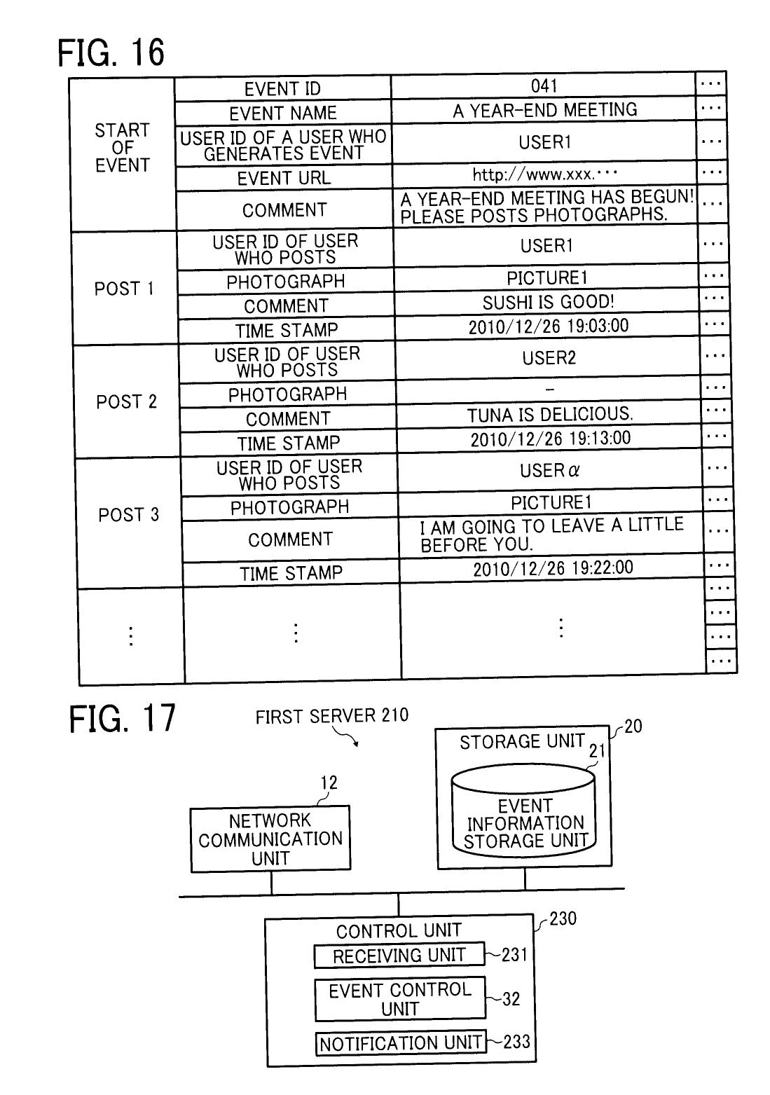

The event screen illustrating repeated posting action is displayed in FIG. 15. The name of a second user (the user identification of the second user) that has posted a comment and the amount of time that has elapsed since the post was displayed on the event screen is illustrated in FIG. 15. FIG. 16 is a diagram illustrating the event information table according to a same phase as the phase of the event screen illustrated in FIG. 15. Further, in this embodiment, the most recent message is displayed on the upper position on the event screen as is illustrated in FIG. 15. This is the case so that a user is able to see the more resent messages first.

The first server transmits a notification, indicating that the action for the event provided by the first server 10 has been performed, to the user of the second service (the first following user) in the second service provided by the second server 50. Thus, the user of the second service is encouraged to participate in the event provided by the first server 10.

### Second Embodiment

The second embodiment of the present invention will now be described with reference to the above-described first embodiment. Descriptions of the configurations having the reference numerals the same as those in the first embodiment are omitted unless there is a special necessity. In the second embodiment, the presence or absence of a notification from the first server to the second server is selectable.

FIG. 17 is a block diagram of a first server 210 according to the second embodiment of the present invention. As illustrated in FIG. 17, the first server 210 in the second embodiment is different from the first server 10 in the first embodiment in that the first server 210 includes a receiving unit 231 and a notification unit 233 in the control unit 230.

The receiving unit 231 further receives determination information. The determination information indicates the presence or absence of a notification from the first user terminal 80 to the second server 50.

Further, it is also possible that the receiving unit 231 receives the determination information from the first user terminal 80, every time the first user performs an action relating to the event with the first user terminal 80. In this case, the first user inputs determination information about the action every time the first user performs action for the event. Thus, the first user is able to manually select whether or not a notification is transmitted from the first server 210 to the second server 50 for each action.

Alternatively, it is also possible that the receiving unit 231 receives the determination information which indicates the setting for all actions from the first user terminal 80. In this case, the first user accesses the first server 210 and inputs the determination information which applies to all actions on a setting screen via the first user terminal 80. Thus, the first user is able to manually select whether or not a notification is transmitted from the first server 210 to the second server 50 for all actions across the board.

In the case in which the determination information, which received by the receiving unit 231, indicates the presence of a notification, the notification unit 233 transmits a notification including the user identification of the first user, the event address, and the action performed information, to the second server 50.

Thus, in the second embodiment, in the case in which the determination information indicates the presence of a notification, the first server 210 transmits a notification that indicates that an action has been performed to the second server 50. Therefore, only actions which the first user wishes to have other users (the following users) be notified of are transmitted.

### Third Embodiment

The third embodiment of the present invention will now be described with reference to the above-described first embodiment. Descriptions of the configurations having the reference numerals the same as those in the first embodiment are omitted unless there is a special necessity. In the third embodiment, the presence or absence of a notification from the first server to the second server is able to be selected for each type of action.

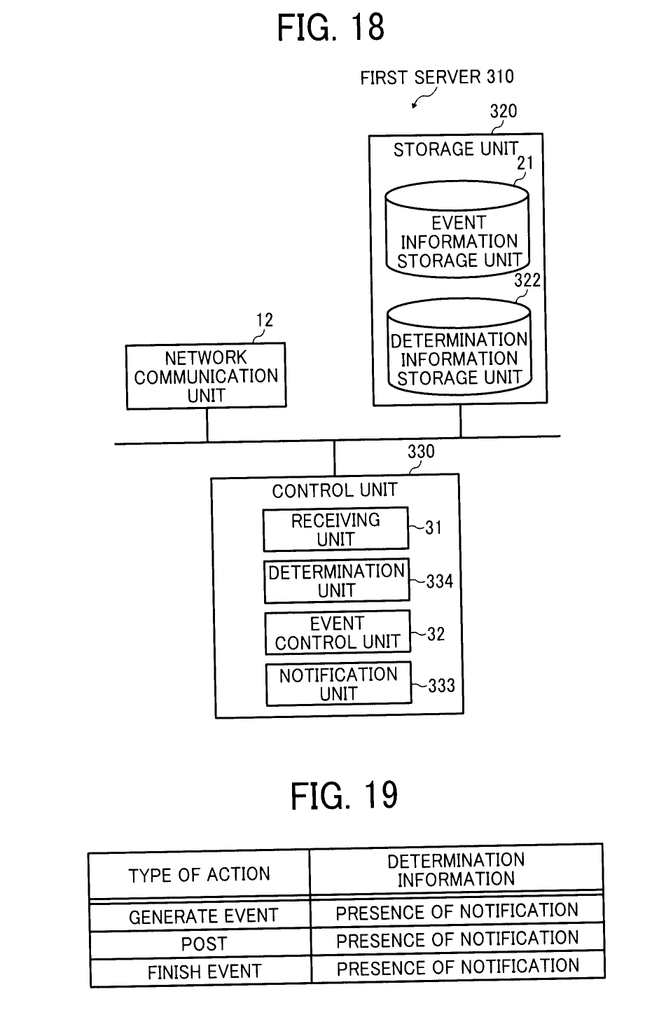

FIG. 18 is a block diagram of a first server according to the third embodiment of the present invention. As illustrated in FIG. 18, a first server 310 in the third embodiment is different from the first server 10 in the first embodiment in that the storage unit 320, in the first server 310, additionally includes a determination information storage unit 322. In addition, the control unit 330, in the first server 310, additionally includes the determination unit 334, along with a notification unit 333.

The determination information storage unit 322 stores determination information which indicates whether a notification should be transmitted from the first server 310 to the second server 50 for each type of action. For example, as illustrated in FIG. 19, the determination information storage unit 322 stores determination information which is associated with a certain type of action such as generating an event, posting a photograph and a comment, finishing an event, and so on. In this example, each type of action is initially set as permitting the presence of a notification. The first user accesses the first server 310 and inputs determination information for each type of action on a setting screen via the first user terminal 80. The receiving unit 31 receives determination information for each type of action, from the first user terminal 80. And a determination information storage unit 322 stores determination information corresponding to the each type of action.

The determination unit 334 determines whether to transmit a notification including the action information to the second server 50 based on the type of action indicated by the action information received with the receiving unit 31. Concretely, the determination unit 34, with reference to determination information, which provides an indication for each type of action stored in a determination information storage unit 322, determines whether to transmit a notification including the action information, which is received by the receiving unit 31, to the second server 50.

In the case in which the determination unit 334 determines that a notification including the action should be transmitted to the second server 50, a notification unit 333 transmits, to the second server 50, the notification including the user identification information of the first user, the event address of the event, and the action performed information. In the case in which the determination unit 334 determines that a notification including the action should not be transmitted to the second server 50, the notification unit 333 does not transmit a notification to the second server 50.

In third embodiment, in the case in which a notification including the action should be transmitted to the second server 50, the first server 210 transmits the notification, to the second server 50, including an indication that action has been performed. Thus, a notification for only a particular action is transmitted.

### Fourth Embodiment

The fourth embodiment of the present invention will now be described with reference to the above-described first embodiment. Descriptions of the configurations having reference numerals the same as those in the first embodiment are omitted unless there is a special necessity. In the fourth embodiment, the presence or absence of a notification from the first server to the second server is able to be selected based on the activity level.

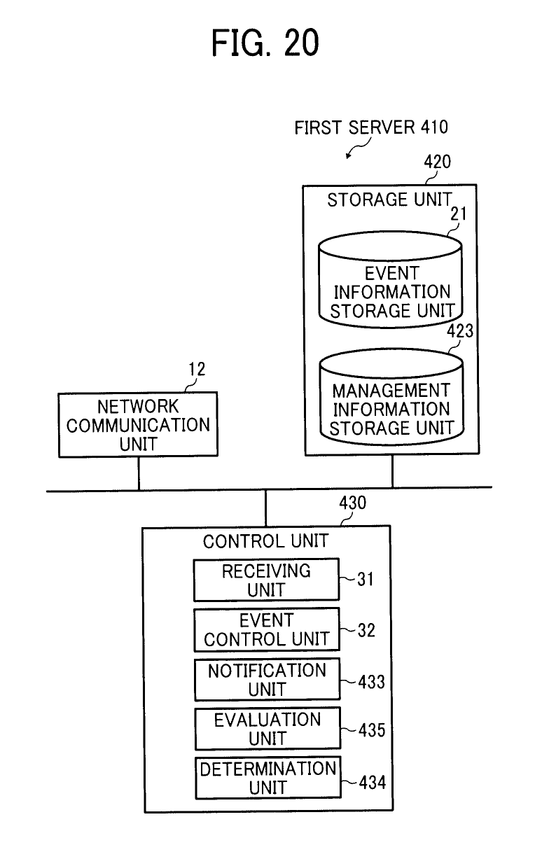

FIG. 20 is a block diagram of a first server 410 according to the fourth embodiment of the present invention. As illustrated in FIG. 20, the first server 410, in the fourth embodiment, is different from the first server 10, in the first embodiment, in that a storage unit 420 in the first server 410 additionally includes a management information storage unit 423. In addition, a control unit 430 in the first server 410 additionally includes an evaluation unit 435 and a determination unit 434 along with a notification unit 433.

The management information storage unit 423 stores administrator identification information which identifies an administrator of the first service. The management information storage unit 423 stores account information of the administrator (user ID and password) as administrator identification information.

An evaluation unit 435 evaluates the activity level of the event. Concretely, the evaluation unit periodically evaluates the activity level of the event based on the number of times that the event is browsed within a particular period, number of times, within particular period, that an action is performed for the event and the previous activity level. The number of times that an action has been performed includes at least one of a number of posts, a number of likes (support indications), and a total number of posts and likes. The evaluation unit 435 evaluates active level with function (1)

JRₙ=[JRₙ₋₁+{cPₙ/P_{M}Tₚ*100}]/2 (1)

JRₙ indicates an activity level. And JRₙ₋₁ indicates the previous activity level. c indicates a weighted coefficient. Pₙ indicates a score within a particular period. P_{M} indicates a maximum score within the particular period. Tₚ indicates the particular period. The score within particular period is evaluated based on the number of times in which an activity is browsed within the particular period and the number of times an action is performed for the event within the particular period. Evaluating the activity level based on function (1), an increase of the number of time the event is browsed and the number of posted times, increases the value of the activity level.

The determination unit 434 determines whether the activity level evaluated by the evaluation unit 435 is greater than a threshold value or not.

In the case in which the determination unit 434 determines the activity level is greater than the threshold value, the notification unit 433 transmits a notification, to the second server 50, including the administrator identification information and the event address. In the case in which the determination unit 434 determines the activity level is not greater than the threshold value, the notification unit 433 does not transmit the notification.

Thus, in the fourth embodiment, in the case in which activity level is high, the first server 410 transmits a notification including the event address of the event as a administrator of a first service. As a result the user of a second service will be encouraged to participate in the event provided by the first server 410.

### Fifth Embodiment

The fifth embodiment of the present invention will now be described with reference to the above-described first embodiment. Descriptions of the configurations having reference numerals the same as those in the first embodiment are omitted unless there is a special necessity. In the fifth embodiment, in the case in which a user, who is being followed by the first user, posts to the event, the first server transmits a notification to the second server.

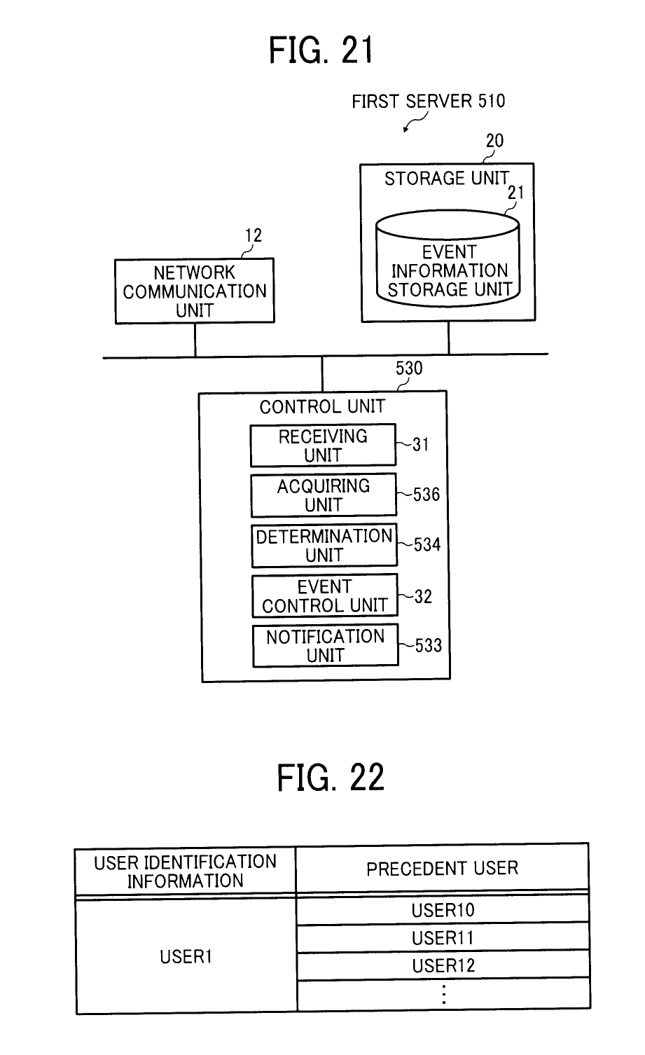

FIG. 21 is a block diagram of the first server according to the fifth embodiment of the present invention. As illustrated in FIG. 21, the first server 510, in the fifth embodiment, is different from the first server 10, in the first embodiment, in that a control unit 530, in the first server 510, additionally includes an acquiring unit 435 and a determination unit 534 along with the notification unit 533.

The acquiring unit 536 acquires the first precedent user table, which includes the user identification of the first user and the precedent user identification, which indicates the user identification of the first precedent user. The first precedent user is a user who is followed by the first user (i.e. the first user is subscribed to the output of the precedent user). For example, as is illustrated in FIG. 22, the acquiring unit 536 acquires the first precedent user table, which includes information of “user 1 ”(the user identification of the first user) along with information of “user 10” and so on (the precedent user identification indicating the user identification of the first precedent user who is being followed by the first user).

The determination unit 534 determines whether the user identification information of the user who generates the event is equivalent to the user identification of the first precedent user, with reference to the first precedent user table acquired by the acquiring unit 536. Concretely, the determination unit 534 acquires the user identification of the user who generates the event from the event information storage unit 21 and, determines whether there is a user identification of a first precedent user which is equivalent to the acquired user identification in the first precedent user table. In this exemplary embodiment, the first user (“user1”) has created the event. So, as is illustrated in FIG. 22, the determination unit 534 determines that “user1”, which is the user identification of the user who generates the event, is not equivalent to the user identification of the first precedent user in the first precedent user table.

In the case in which the determination unit 534 determines that the user identification of the user who generates the event is equivalent to the user identification of the first precedent user in the first precedent user table, the notification unit 533 transmits a notification, to the second server 50, including the user identification of the first user, the event address, and the action performed information. In the case in which the determination unit 534 determines that the user identification of the user who generates the event is not equivalent to the user identification of the first precedent user in the first precedent user table, the notification unit 533 does not transmit a notification to the second server 50.

Thus, in the fifth embodiment, in the case in which the determination unit 534 determines that the user identification of the user who generates the event is equivalent to the user identification of the first precedent user, the notification unit 533 transmits a notification, to the second server 50, including the user identification of the first user, the event address, and the action performed information. Thus, the following user can be made aware of actions for the event which are generated by the first precedent user. And as a result, the user of the second service can be encouraged to participate in the event generated by the precedent user.

### Sixth Embodiment

The sixth embodiment of the present invention will now be described with reference to the above-described first embodiment. Descriptions of the configurations having reference numerals the same as those in the first embodiment are omitted unless there is a special necessity. In the sixth embodiment, the first server transmits a notification indicating that the first user has performed the action for the event.

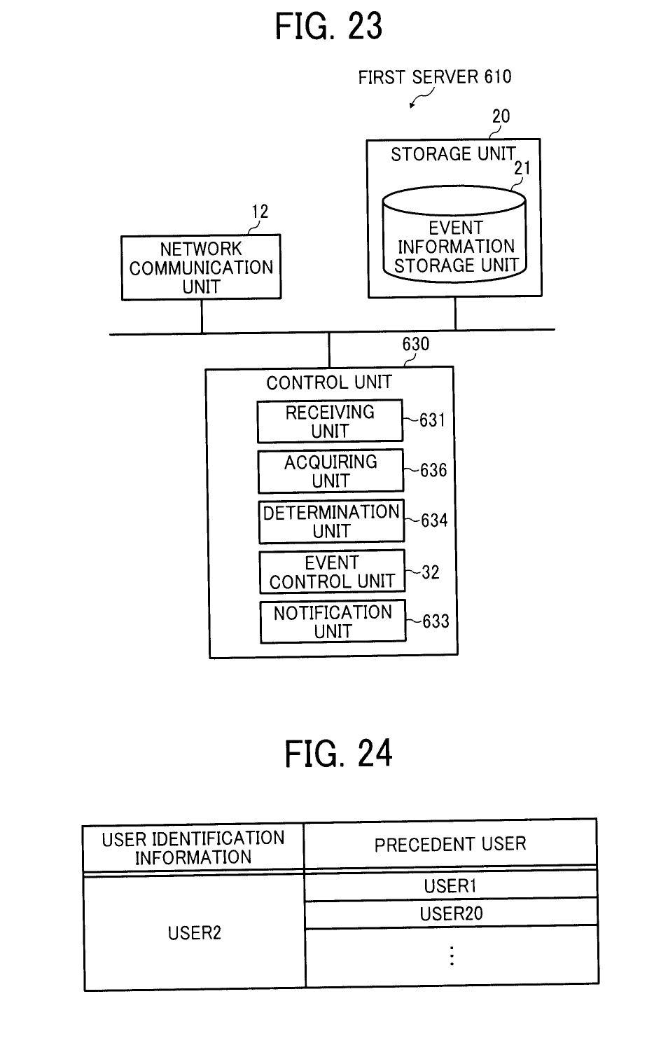

FIG. 23 is a block diagram of the first server according to the sixth embodiment of the present invention. As illustrated in FIG. 23, the first server 610, in the sixth embodiment, is different from the first server 10, in the first embodiment, in that the control unit 630 additionally includes an acquiring unit 636 and a determination unit 634 along with the receiving unit 631 and the notification unit 633.

The receiving unit 631 receives, from the second user terminal 90, the second user identification information identifying the second user who uses the second user terminal 90. For example, the receiving unit 631 receives, from the second user terminal 90, which has installed thereon an application for optimizing the user interface (UI) of the first service, the account information of the second user at regular intervals by using polling. As premises for this example, as is assumed in the first embodiment, it is assumed that the second user who uses the second user terminal 90 is the first following user of the first user.

The acquiring unit 636 acquires, from the second server 50, a second precedent user table which includes the user identification of the second user and the precedent user identification identifying the second precedent user who is being followed by the second user. For example, as is illustrated in FIG. 24, the acquiring unit 636 acquires the second precedent user table, which includes the information of “user2” (the user identification of the second user) and the information of “user 1” and so on (the precedent user identification indicating the user identification of the second precedent user who is being followed (subscribed) by the second user).

The determination unit 634 determines whether the user identification information of the first user is equivalent to the user identification of the second precedent user, by referencing the second precedent user table acquired by the acquiring unit 636. Concretely, the determination unit 634 determines whether there is a user identification of a first precedent user which is equivalent to the acquired user identification of the first user in the second precedent user table. In the exemplary embodiment illustrated in FIG. 24, the second precedent user is the first user (“user1”) and so on. Therefore the determination unit 634 determines that “user1”, which is the user identification of the first user, is equivalent to the user identification of the second precedent user.

In the case in which the determination unit 634 determines the user identification information of the first user is equivalent to the user identification of the second precedent user, the notification unit 633 transmits a notification, to the second user terminal 90, including the event address and the action performed information. Thus, information indicating that the action has been performed is displayed on a standby screen of the second user terminal 90. When the second user designates the information, the event screen illustrated, for example, in FIG. 11 is displayed on the second user terminal 90. In the case in which the determination unit 634 determines that the user identification information of the first user is not equivalent to the user identification of the second precedent user, the notification unit 633 does not transmit a notification.

Thus, in the sixth embodiment, the notification unit 533 transmits a notification, to the other users (i.e. the first following user), indicating that an action has been performed for the event provide by the first server 610. Thus, the user of the second service can be encouraged to participate in the event provided by the first server.

As one of ordinary skill in the art would recognize, the computer microprocessor noted in the description above can be implemented as discrete logic gates, as an Application Specific Integrated Circuit (ASIC), a Field Programmable Gate Array (FPGA) or other Complex Programmable Logic Device (CPLD). An FPGA or CPLD implementation may be coded in VHDL, Verilog or any other hardware description language and the code may be stored in an electronic memory directly within the FPGA or CPLD, or as a separate electronic memory. Further, the electronic memory may be non-volatile, such as ROM, EPROM, EEPROM or FLASH memory. The electronic memory may also be volatile, such as static or dynamic RAM, and a processor, such as a microcontroller or microprocessor, may be provided to manage the electronic memory as well as the interaction between the FPGA or CPLD and the electronic memory.

Alternatively, the computer processor may execute a computer program including a set of computer-readable instructions that perform the functions described herein, the program being stored in any of the above-described non-transitory electronic memories and/or a hard disk drive, CD, DVD, FLASH drive or any other known storage media. Further, the computer-readable instructions may be provided as a utility application, background daemon, or component of an operating system, or combination thereof, executing in conjunction with a processor, such as a Xenon processor from Intel of America or an Opteron processor from AMD of America and an operating system, such as Microsoft VISTA, UNIX, Solaris, LINUX, Apple, MAC-OSX and other operating systems known to those skilled in the art.

The processor can be included in a device that includes a bus or other communication mechanism for communicating information, and a processor/CPU coupled with the bus for processing the information. The device also includes a main memory/memory unit, such as a random access memory (RAM) or other dynamic storage device (e.g., dynamic RAM (DRAM), static RAM (SRAM), and synchronous DRAM (SDRAM)), coupled to the bus for storing information and instructions to be executed by processor/CPU. In addition, the memory unit may be used for storing temporary variables or other intermediate information during the execution of instructions by the CPU. The device may also further include a read only memory (ROM) or other static storage device (e.g., programmable ROM (PROM), erasable PROM (EPROM), and electrically erasable PROM (EEPROM)) coupled to the bus for storing static information and instructions for the CPU.

The device may also include a disk controller coupled to the bus to control one or more storage devices for storing information and instructions, such as mass storage, and drive device (e.g., floppy disk drive, read-only compact disc drive, read/write compact disc drive, compact disc jukebox, tape drive, and removable magneto-optical drive). The storage devices may be added to the device using an appropriate device interface (e.g., small device system interface (SCSI), integrated device electronics (IDE), enhanced-IDE (E-IDE), direct memory access (DMA), or ultra-DMA).

The device may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The device may also include a display controller coupled to the bus to control a display, such as a cathode ray tube (CRT), for displaying information to a device user. The device includes input devices, such as a keyboard and a pointing device, for interacting with a device user and providing information to the processor. The pointing device, for example, may be a mouse, a trackball, or a pointing stick for communicating direction information and command selections to the processor and for controlling cursor movement on the display. In addition, a printer may provide printed listings of data stored and/or generated by the device.

The device performs at least a portion of the processing steps of the invention in response to the CPU executing one or more sequences of one or more instructions contained in a memory, such as the memory unit. Such instructions may be read into the memory unit from another computer readable medium, such as the mass storage or a removable media. One or more processors in a multi-processing arrangement may also be employed to execute the sequences of instructions contained in memory unit. In alternative embodiments, hard-wired circuitry may be used in place of or in combination with software instructions. Thus, embodiments are not limited to any specific combination of hardware circuitry and software.

As stated above, the device includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other medium from which a device can read.

Stored on any one or on a combination of computer readable media, the present invention includes software for controlling the main processing unit, for driving a device or devices for implementing the invention, and for enabling the main processing unit to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code elements on the medium of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the CPU for execution. A computer readable medium may take many forms, including but not limited to, non-volatile media, and volatile media. Non-volatile media includes, for example, optical, magnetic disks, and magneto-optical disks, such as the mass storage or the removable media 1001. Volatile media includes dynamic memory, such as the memory unit.

Various forms of computer readable media may be involved in carrying out one or more sequences of one or more instructions to the CPU for execution. For example, the instructions may initially be carried on a magnetic disk of a remote computer. An input coupled to the bus can receive the data and place the data on the bus. The bus carries the data to the memory unit, from which the CPU 1004 retrieves and executes the instructions. The instructions received by the memory unit may optionally be stored on mass storage either before or after execution by the CPU.

The device also includes a communication interface coupled to the bus B. The communication interface provides a two-way data communication coupling to a network that is connected to, for example, a local area network (LAN), or to another communications network such as the Internet. For example, the communication interface may be a network interface card to attach to any packet switched LAN. As another example, the communication interface may be an asymmetrical digital subscriber line (ADSL) card, an integrated services digital network (ISDN) card or a modem to provide a data communication connection to a corresponding type of communications line. Wireless links may also be implemented. In any such implementation, the communication interface sends and receives electrical, electromagnetic or optical signals that carry digital data streams representing various types of information.

The network typically provides data communication through one or more networks to other data devices. For example, the network may provide a connection to another device through a local network (e.g., a LAN) or through equipment operated by a service provider, which provides communication services through a communications network. The local network and the communications network use, for example, electrical, electromagnetic, or optical signals that carry digital data streams, and the associated physical layer (e.g., CAT 5 cable, coaxial cable, optical fiber, etc). Moreover, the network may provide a connection to a mobile device such as a personal digital assistant (PDA) laptop device, or cellular telephone.

The present invention is not limited to the above-described embodiments, and variations and modifications may be made without departing from the basic concepts of the present invention as claimed.

What is claimed is:

1. A server which includes a microprocessor and provides an event, which is of a user participation type, as a first service, comprising:
a receiving unit configured to receive, from a first user terminal connected to the server through a network, action information that identifies an action that corresponds to the event and that is requested by the first user via the first user terminal, and user identification information that distinguishes the first user;
an event control unit configured to perform the action which is identified by the action information;
a notification unit configured to transmit a notification, to a second server which provides a second service and is connected to the server through the network, the notification including the user identification of the first user, address information that identifies an address of the event, and action information indicating that the action has been performed.

2. The server as claimed in claim 1,
wherein the receiving unit is further configured to receive, from the first user terminal, determination information which indicates whether the notification from the server to the second server is permitted,
the notification unit is further configured to transmit a notification including the user identification of the first user, the event address, and the action performed information, to the second server, in the case in which the determination information indicates that the notification is permitted.

3. The server as claimed in claim 1, further comprising:
a determination unit configured to determine whether to transmit a notification including the action information to the second server based on a type of action indicated by the action information, and
wherein the notification unit is further configured to transmit the notification including the user identification of the first user, the event address, and the action performed information, to the second server, in the case in which the determination unit determines to transmit the notification based on the action information.

4. The server as claimed in claim 1, further comprising:
an evaluation unit configured to evaluate an activity level of the event;
a determination unit configured to determine whether or not the activity level is greater than a threshold value, and
wherein the notification unit is further configured to transmit the notification, to the second server, including an administrator identification information, which indicates an administrator of the first service, and the event address, in the case in which the determination unit determines that the activity level is greater than the threshold value.

5. The server as claimed in claim 4,
wherein the evaluation unit is further configured to periodically evaluate the activity level of the event based on a number of times the event is browsed within a particular period, a number of times an action is performed for the event within the particular period, and a previous activity level.

6. The server as claimed in claim 1, further comprising:
an acquiring unit configured to acquire, from the second server, a precedent user table, which includes information of the user identification of the first user and a precedent user identification, which indicates a user identification of a precedent user who is followed by the first user, the first user following the precedent user by subscribing to output of the precedent user;
a determination unit configured to determine whether the user identification information of a user who performs the event is equivalent to the user identification of the precedent user, by referring to a precedent user table, and
wherein the notification unit is further configured to transmit the notification, to the second server, including the user identification of the first user, an event address, and action performed information.

7. The server as claimed in claim 1, further comprising:
an acquiring unit configured to acquire, from the second server, a precedent user table which includes information of the user identification of a second user and a precedent user identification, which indicates a user identification of a precedent user who is followed by the second user, the second user following the precedent user by subscribing to output of the precedent user;
a determination unit configured to determine whether the user identification information of the first user is equivalent to the user identification of the precedent user by referring to the precedent user table, and
wherein the notification unit is further configured to transmit a notification, to a second user terminal, including the event address and action performed information.

8. The server as claimed in claim 1,
wherein the action includes at least one of an action that generates the event, a posting action that posts a photograph and a message, and a finishing action that finishes the event.

9. A system includes a first server which includes a microprocessor and provides an event, which is of a user participation type, as a first service and a second server which includes a microprocessor and provides a second service and is connected to the first server through a network, comprising:
the first server including
a receiving unit configured to accept, from a first user terminal connected to the first server through the network, action information, which identifies an action that corresponds to the event and that is requested by the first user via the first user terminal, and user identification information that distinguishes the first user;
an event control unit configured to perform the action which is identified by the action information;
a notification unit configured to transmit a notification, to the second server, the notification including the user identification of the first user, address information that identifies an address of the event, and action information indicating that the action has been performed,
a second server comprising:
a transmitting unit configured to post, as the first user in the second service, a message indicating that the action has been performed and including the event address based on the user identification, the address information, and the action information.

10. A method of providing an event, which is of a user participation type, as a first service using a server including a microprocessor, comprising:
accepting, from a first user terminal through a network, action information that identifies an action that corresponds to the event and that is requested by the first user via the first user terminal, and user identification information that distinguishes the first user;
performing the action which is identified by the action information;
transmitting a notification, to a second server which provides a second service and is connected to the server through the network, the notification including the user identification of the first user, address information that identifies an address of the event, and action information indicating that the action has been performed.

11. The method as claimed in claim 10, further comprising:
receiving, from a first user terminal, determination information which indicates whether a notification from the server to the second server is permitted; and
transmitting a notification including the user identification of the first user, the event address, and the action performed information, to the second server, in the case in which the determination information indicates that the notification is permitted.

12. The method as claimed in claim 10, further comprising: determining whether to transmit a notification including the action information to the second server based on a type of action indicated by the action information; and
transmitting the notification including the user identification of the first user, the event address, and the action performed information, to the second server, in the case the determining determines to transmit the notification based on the action information.

13. The method as claimed in claim 10, further comprising:
evaluating an activity level of the event;
determining whether or not the activity level is greater than a threshold value; and
transmitting the notification, to the second server, including an administrator identification information, which indicates an administrator of the first service, and the event address, in the case in that the activity level is greater than the threshold value.

14. The method as claimed in claim 13, further comprising:
periodically evaluating the activity level of the event based on a number of times the event is browsed within a particular period, a number of times an action is performed for the event within the particular period, and a previous activity level.

15. The method as claimed in claim 10, further comprising:
acquiring, from the second server, a precedent user table, which includes information of the user identification of the first user and a precedent user identification, which indicates a user identification of a precedent user who is followed by the first user, the first user following the precedent user by subscribing to output of the precedent user;
determining whether the user identification information of a user who performs the event is equivalent to the user identification of the precedent user, by referring to the precedent user table; and
transmitting the notification, to the second server, including the user identification of the first user, an event address, and action performed information.

16. The method as claimed in claim 10, further comprising:
acquiring, from the second server, a precedent user table which includes information of the user identification of a second user and a precedent user identification, which indicates a user identification of a precedent user who is followed by the second user, the second user following the precedent user by subscribing to output of the precedent user;
determining whether the user identification information of the first user is equivalent to the user identification of the precedent user by referring to the precedent user table; and
transmitting a notification, to a second user terminal, including the event address and action performed information.

17. The method as claimed in claim 10, wherein the action includes at least one of an action that generates the event, a posting action that posts a photograph and a message, and a finishing action that finishes the event.

18. A non-transitory computer readable medium having stored thereon a program that when executed by a server causes the server to implement a method of providing an event, which is of a user participation type, as a first service, the method comprising:
accepting, from a first user terminal through a network, action information that identifies an action that corresponds to the event and that is requested by the first user via the first user terminal, and user identification information that distinguishes the first user;
performing the action which is identified by the action information;
transmitting a notification, to a second server which provides a second service and is connected to the server through the network, the notification including the user identification of the first user, address information that identifies an address of the event, and action information indicating that the action has been performed.
